(19) United States
(12) Patent Application Publication
(10) Pub. No.: US 2015/0278176 A1
(43) Pub. Date: Oct. 1, 2015

(54) PROVIDING FOR TEXT ENTRY BY A USER OF A COMPUTING DEVICE

(71) Applicant: Nuance Communications, Inc., Burlington, MA (US)

(72) Inventors: Claes-Fredrik Mannby, Vashon, WA (US); Keith Trnka, Seattle, WA (US)

(21) Appl. No.: 14/312,584

(22) Filed: Jun. 23, 2014

Related U.S. Application Data
(63) Continuation of application No. 14/231,550, filed on Mar. 31, 2014.

(51) Int. Cl. G06F 17/24; G06F 3/0482; G06F 3/0484

(52) U.S. Cl. CPC G06F 17/24; G06F 3/04842; G06F 3/0482

(57) ABSTRACT

A method and system for receiving text input via a computing device generates a graphical text element interface showing text elements arranged to provide for efficient selection by a user. Text elements show a single character, a group of characters, words, or phrases. And by selecting a text element, the user submits text in the computing device. The system may identify text elements to display based at least in part on a previous selection of a text element by a user.

### CROSS-REFERENCE TO RELATED APPLICATION(S)

This application is a continuation of U.S. patent application Ser. No. 14/231,550, filed Mar. 31, 2014, entitled “PROVIDING FOR TEXT ENTRY BY A USER OF A COMPUTING DEVICE,” which is incorporated herein by reference.

### BACKGROUND

Computing devices have taken new form factors as they have evolved to meet growing needs of consumers. For instance, smartphones and tablet computers are sized to be held in a person's hands and carried in a pocket or bag, whereas wearable devices are configured to be incorporated in clothing or accessories and worn by a user, and gaming consoles are incorporated in home entertainment systems positioned away from users. But as the shapes and sizes of these devices have been transformed to meet new applications, conventional methods for interacting with them have been compromised.

Most computing devices receive or would benefit from receiving text input from a user. Devices currently provide for text entry through several mechanisms. Some devices include hardware keyboards. Some include no physical keyboard but have touchscreens that display virtual keyboards or include audio recorders that record and analyze speech to identify spoken words. Others have sensors that monitor a user's gestures to identify text input. However, even the most advanced input mechanisms can be cumbersome for users, as they are limited by a device's size and shape and by the use of the device.

Some devices have applications that assist a user in submitting text. These applications may utilize “next word prediction” algorithms to display a list of words, typically horizontally above a virtual keyboard, that are predicted based at least in part on text already entered by a user. The user may select a displayed word to submit that text. But limited by display size and a user's ability to rapidly digest displayed information, conventional next word prediction systems are unable to adequately compensate for inefficiencies inherent in text input mechanisms.

The need exists for a system that overcomes the above problems, as well as one that provides additional benefits. Overall, the examples herein of some prior or related systems and their associated limitations are intended to be illustrative and not exclusive. Other limitations of existing or prior systems will become apparent to those of skill in the art upon reading the following Detailed Description.

### BRIEF DESCRIPTION OF THE DRAWINGS

FIG. 1 is a diagram of a suitable environment in which a text entry system operates.

FIG. 2 is a block diagram of a device in which a text entry system operates.

FIG. 3 is a system diagram of a text entry system.

FIG. 4 is a flow diagram depicting a method performed by a text entry system to receive text input from a user of a device.

FIG. 5 is a flow diagram depicting a method performed by a text entry system to display and update text elements based on a selection by a user of a text element.

FIGS. 6A and 6B show representative graphical text element interfaces.

FIGS. 7A-C show representative graphical text element interfaces of various sizes.

FIG. 8 shows a representative graphical text element interface for a text entry system operating in a limited feature device.

### DETAILED DESCRIPTION

A method and system are described for receiving text input via a computing device. The system generates a graphical user interface showing text elements selected and arranged to provide for efficient selection by a user. “Text elements” can range from text of a single character (e.g., a letter, a number, or a symbol), to a group of characters (e.g., a prefix of a word), to words, or even phrases. For the sake of conciseness, text elements are described herein mainly as being associated with text. However, text elements may also be graphical. And by selecting a text element, the user submits text or a graphic in the computing device, depending on the text element selected.

The system can identify for display a default set of text elements. For example, before receiving any selection from a user of a text element, the system may display a predetermined set of text elements arranged in rows. But in many scenarios, the system identifies text elements to display and arranges the identified text elements based at least in part on a previous selection by a user. For example, after receiving a selection by a user of a first text element, the system may identify text elements to display that it predicts are likely to be desired by the user based on the selection of the first text element.

As a more particular example, the system identifies an arrangement for text elements, such as in groups that are aligned along an axis, forming a table. Before receiving a user's selection of a text element, the system displays a default arrangement of text elements. A first column of the table includes rows of text elements corresponding to letters of the alphabet. And subsequent columns include rows of text elements corresponding to combinations of the letter of the first column and additional characters. For example, the text element of the first row, first column could correspond to ‘a,’ an adjacent text element in the first row may correspond to “and,” a third text element of the row may correspond to “are,” and so forth, with each text element corresponding to a popular word that begins with the letter A. In some implementations, after a text element is selected by a user, the system identifies new text elements to display, chosen based at least in part on the user's previous selection.

Because the system can be deployed in many different types of devices, it may receive user input in many ways. Indeed, a user's selection can be received via touch-sensitive sensors, infrared sensors, cameras, controllers (e.g., video game controllers), microphones, motion sensors, television remote controls, and so forth, depending on the device. In some implementations, the system receives different types of selections from the user, each type of selection corresponding to a different action. If the system receives a first type of selection, it takes a first action with respect to the text element. If it receives a second type of selection, it takes a second action with respect to the text element. For example, operating in a touchscreen device, the system may interpret a received tap on a text element as a selection to enter all text associated with that text element. But the system may interpret a received swipe left starting on the text element as a selection to submit only a portion of the text associated with the text element (e.g., two letters). In some implementations, the system receives a gesture, and the system interprets the gesture and enters text associated with the received gesture to the text buffer or adds it to a prefix. The system may also receive handwritten input and add a character recognized in the handwritten text to a prefix, or output the recognized character to the text buffer. In some implementations, the system receives a handwritten input of a punctuation mark and automatically adds the punctuation mark to the text buffer. The system can treat user input ambiguously so that a received input is associated with a selection of two or more text elements. For example, the system may receive a user input of a tap on a text element corresponding to the letter M. The system may process the input as a probable selection of the text element for the letter M as well as a possible selection of the text elements for the letters arranged adjacent to the text element for the letter M (e.g., the text elements for the letters L and N on an alphabetical arrangement of text elements).

Various implementations of the invention will now be described. The following description provides specific details for a thorough understanding and an enabling description of these implementations. One skilled in the art will understand, however, that the invention may be practiced without many of these details. Additionally, some well-known structures or functions may not be shown or described in detail, so as to avoid unnecessarily obscuring the relevant description of the various implementations. The terminology used in the description presented below is intended to be interpreted in its broadest reasonable manner, even though it is being used in conjunction with a detailed description of certain specific implementations of the invention.

### Suitable Environments

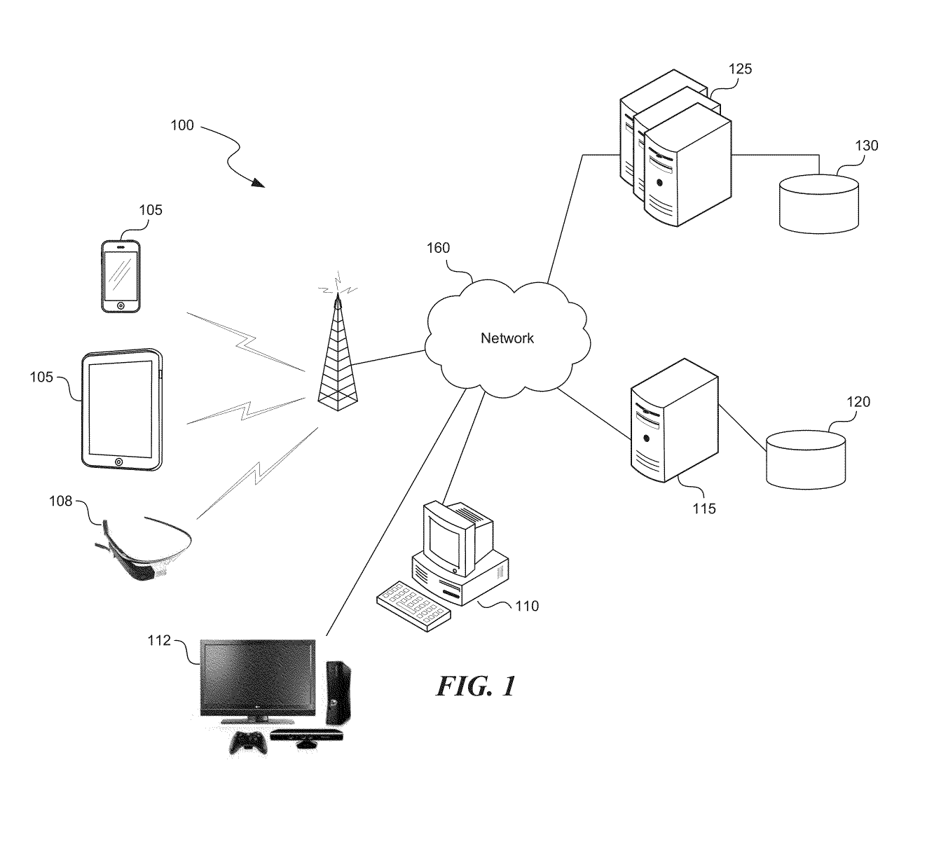

FIG. 1 and the following discussion provide a brief, general description of a suitable computing environment 100 in which a system for receiving text entry, as described herein, can be implemented. Although not required, aspects and implementations of the invention will be described in the general context of computer-executable instructions, such as routines executed by a general-purpose computer, a personal computer, a server, or other computing system. The invention can also be embodied in a special purpose computer or data processor that is specifically programmed, configured, or constructed to perform one or more of the computer-executable instructions explained in detail herein. Indeed, the terms “computer” and “computing device,” as used generally herein, refer to devices that have a processor and non-transitory memory, like any of the above devices, as well as any data processor or any device capable of communicating with a network. Data processors include programmable general-purpose or special-purpose microprocessors, programmable controllers, application-specific integrated circuits (ASICs), programmable logic devices (PLDs), or the like, or a combination of such devices. Computer-executable instructions may be stored in memory, such as random access memory (RAM), read-only memory (ROM), flash memory, or the like, or a combination of such components. Computer-executable instructions may also be stored in one or more storage devices, such as magnetic or optical-based disks, flash memory devices, or any other type of non-volatile storage medium or non-transitory medium for data. Computer-executable instructions may include one or more program modules, which include routines, programs, objects, components, data structures, and so on that perform particular tasks or implement particular abstract data types.

The system and method can also be practiced in distributed computing environments, where tasks or modules are performed by remote processing devices, which are linked through a communications network 160, such as a Local Area Network (“LAN”), Wide Area Network (“WAN”), or the Internet. In a distributed computing environment, program modules or subroutines may be located in both local and remote memory storage devices. Aspects of the invention described herein may be stored or distributed on tangible, non-transitory computer-readable media, including magnetic and optically readable and removable computer discs, stored in firmware in chips (e.g., EEPROM chips). Alternatively, aspects of the invention may be distributed electronically over the Internet or over other networks (including wireless networks). Those skilled in the relevant art will recognize that portions of the invention may reside on a server computer, while corresponding portions reside on a client computer. Data structures and transmission of data particular to aspects of the invention are also encompassed within the scope of the invention.

Referring to the example of FIG. 1, a system according to embodiments of the invention operates in or among mobile devices 105, wearable computers 108, personal computers 110, video game systems 112, and one or more server computers 115. The mobile devices 105, wearable computers 108, personal computers 115, and video game systems 112 communicate through one or more wired or wireless networks 160 with the server 115. A data storage area 120 contains data utilized by the system, and, in some implementations, software necessary to perform functions of the system. For example, the data storage area 120 may contain text elements and text element metadata.

The system communicates with one or more third party servers 125 via public or private networks. The third party manager servers include servers maintained by entities, such as social networks and search providers, that send word usage statistics, and the like, to the server 115 or to a computing device (e.g., mobile device 105) over the network. The mobile devices 105, wearable devices 108, computers 110, video game consoles 112, and/or another device or system, display a user interface that includes text elements and receive a selection by the user of a text element.

### Suitable Devices

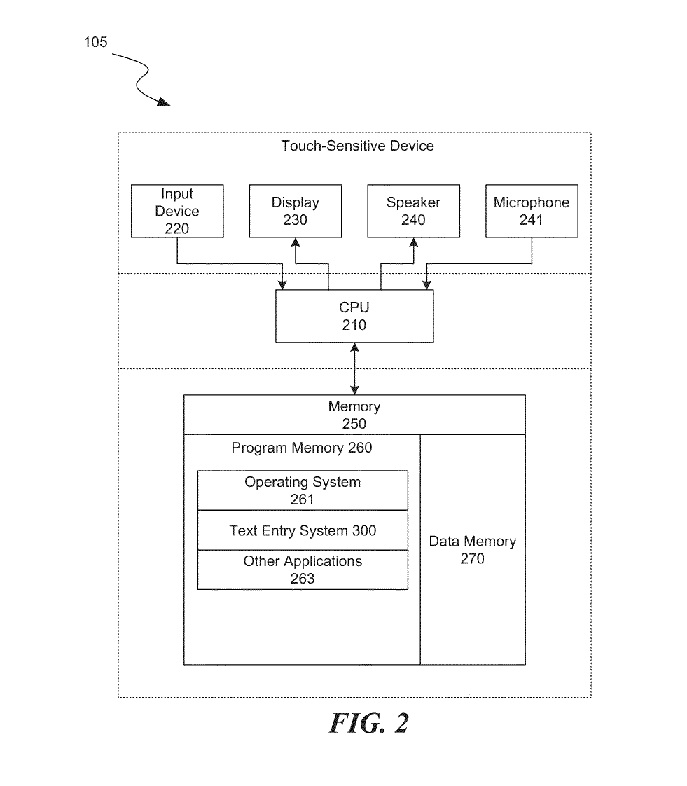

One device in which the disclosed system may operate is a mobile device, such as a smartphone or tablet computer. FIG. 2 is a block diagram illustrating a mobile device 105, including hardware components, for implementing the disclosed technology. The device 105 includes one or more input devices 220 that provide input to the CPU (processor) 210, notifying it of actions performed by a user, such as a tap or gesture. The actions are typically mediated by a hardware controller that interprets the signals received from the input device and communicates the information to the CPU 210 using a known communication protocol. Input devices 220 include, for example, a capacitive touchscreen, a resistive touchscreen, a surface wave touchscreen, a surface capacitance touchscreen, a projected touchscreen, a mutual capacitance touchscreen, a self-capacitance sensor, an infrared touchscreen, an infrared acrylic projection touchscreen, an optical imaging touchscreen, a touchpad that uses capacitive sensing or conductance sensing, or the like. As mentioned above, other input devices that may employ the present system include wearable input devices with accelerometers (e.g. wearable glove-type input devices), a camera- or image-based input device to receive images of manual user input gestures, and so forth. Other input devices may employ keypads and buttons, such as those on a remote control for a television or on a gamepad for a video game console.

The CPU may be a single processing unit or multiple processing units in a device or distributed across multiple devices. Similarly, the CPU 210 communicates with a hardware controller for a display 230 on which text and graphics are displayed. One example of a display 230 is a display of the touchscreen that provides graphical and textual visual feedback to a user. In some implementations, the display includes the input device as part of the display, such as when the input device is a touchscreen. In some implementations, the display is separate from the input device. For example, a touchpad (or trackpad) may be used as the input device 220, and a separate or standalone display device that is distinct from the input device 220 may be used as the display 230. Examples of standalone display devices are: an LCD display screen, an LED display screen, a projected display (such as a heads-up display device), and so on. Optionally, a speaker 240 is also coupled to the processor so that any appropriate auditory signals can be passed on to the user. For example, device 105 may generate audio corresponding to a selected word. In some implementations, device 105 includes a microphone 241 that is also coupled to the processor so that spoken input can be received from the user. In some implementations, a user makes a selection using audio.

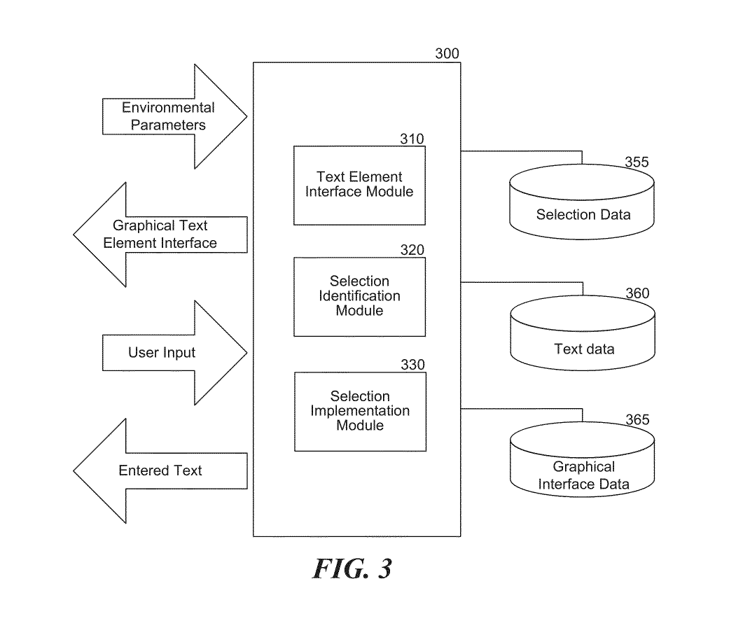

The processor 210 has access to a memory 250, which may include a combination of temporary and/or permanent storage, and both read-only and writable memory (random access memory or RAM), read-only memory (ROM), writable non-volatile memory, such as flash memory, hard drives, floppy disks, and so forth. The memory 250 includes program memory 260 that contains all programs and software, such as an operating system 261, a text entry system 300, which is explained in more detail with respect to FIG. 3, and any other application programs 263. The memory 250 also includes data memory 270 that includes any configuration data, settings, user options and preferences that may be needed by the program memory 260, or any element of the device 105. In some implementations, the memory also includes dynamic template databases to which user/application runtime can add customized templates. The runtime-created dynamic databases can be stored in persistent storage and loaded at a later time.

As mentioned above, in some implementations, the device 105 also includes a communication device capable of communicating wirelessly with a base station or access point using a wireless mobile telephone standard, such as the Global System for Mobile Communications (GSM), Long Term Evolution (LTE), IEEE 802.11, or another wireless standard. The communication device may also communicate with another device or a server through a network using, for example, TCP/IP protocols. For example, device 105 may utilize the communication device to offload some processing operations to the server 115 or to receive word usage or dictionary data from the server 115. In other implementations, once the necessary database entries or dictionaries are stored on device 105, device 105 may perform all the functions required to perform context based text entry without reliance on any other computing devices.

Device 105 may include a variety of computer-readable media, e.g., a magnetic storage device, flash drive, RAM, ROM, tape drive, disk, CD, or DVD. Computer-readable media can be any available storage media and include both volatile and nonvolatile media and removable and non-removable media.

As mentioned above, the disclosed technology is operational with numerous other general purpose or special purpose computing system environments or configurations. Examples of well-known computing systems, environments, and/or configurations that may be suitable for use with the technology include, but are not limited to, personal computers, handheld or laptop devices, cellular telephones, tablet devices, multiprocessor systems, microprocessor-based systems, set-top boxes, programmable consumer electronics, network PCs, minicomputers, mainframe computers, gaming consoles, televisions, e-readers, kiosk machines, wearable computers (e.g., Google Glass™, Samsung Galaxy Gear Smart Watch, etc.), speech generating devices, other devices for the disabled, and distributed computing environments that include any of the above systems or devices, and the like.

It is to be understood that the logic illustrated in each of the following block diagrams and flow diagrams may be altered in a variety of ways. For example, the order of the logic may be rearranged, sub-steps may be performed in parallel, illustrated logic may be omitted, other logic may be included, etc.

### Suitable Systems

FIG. 3 is a block diagram of the text entry system 300. The text entry system identifies text elements to display and receives user input related to the text elements in order to provide for text entry to a computing device by a user. The system 300 may operate in the mobile device 105, wearable computer 108, computer 110, video game console 112, or the like, including in a device for enabling text input by a handicapped person, or it may be distributed among a device and, for example, the server 115. The system includes a text element interface module 310, a selection identification module 320, and a selection implementation module 330. The text entry system 300 writes to and reads data from selection data storage 355, text data storage 360, and graphical interface data storage 365. The system outputs a graphical text element interface and entered text. As described below, the system receives environmental parameters and user input.

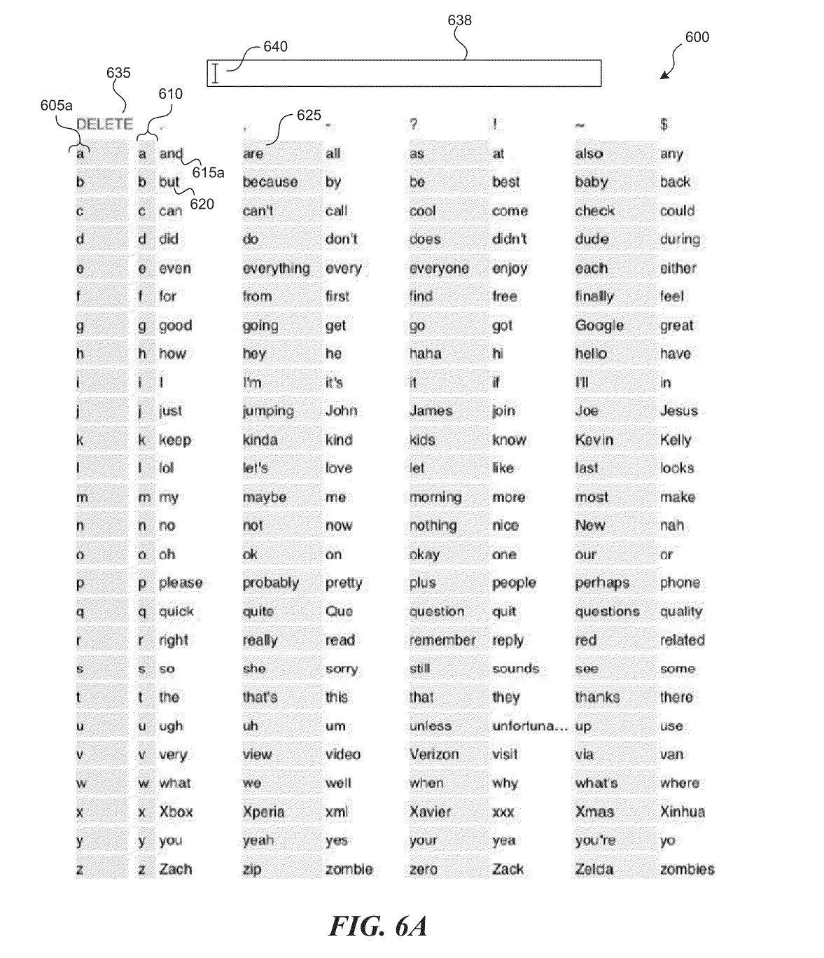

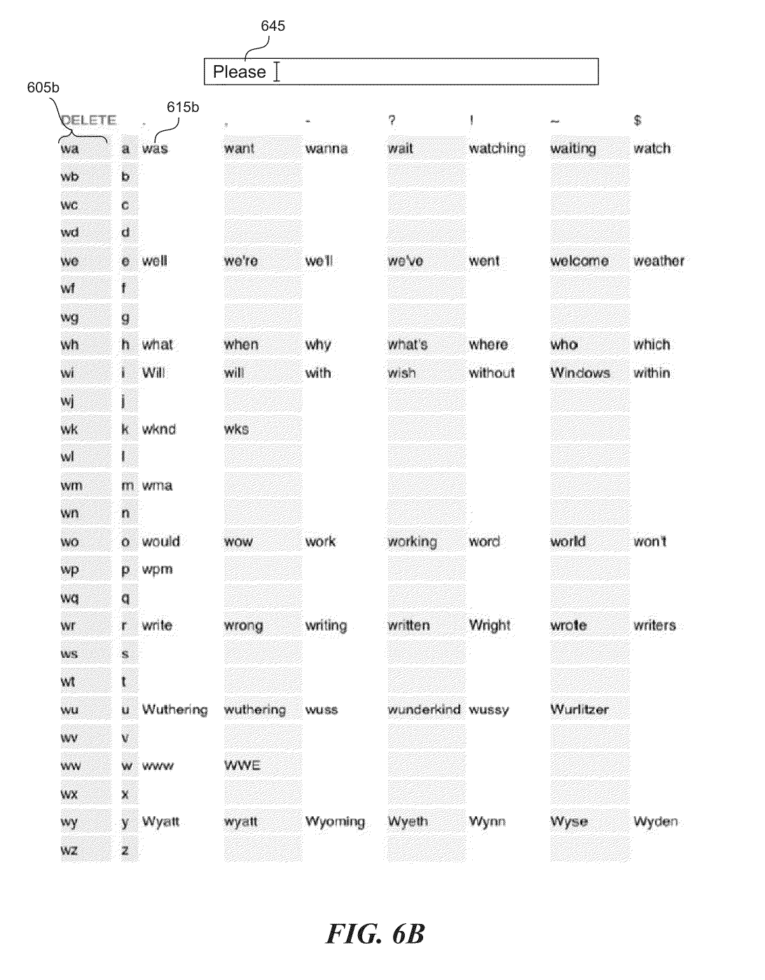

A graphical text element interface is a visual representation of text elements from which a user may select text elements for entering associated text or images. FIG. 6A shows a representative graphical text element interface 600 that includes text elements arranged in a table. Text elements need not be associated with discrete regions of the display they appear on. For example, text elements do not need to be confined to rectangles outlining their displayed keys. Instead, the rectangles or other graphical representations of the text elements may provide a hint for a good location for a user to provide input to make selections, and distances between where user input is received and the general position of a text element can be used to evaluate the likelihood that the user intended to select the text element. A first column 605a includes “prefix” elements. As discussed below, prefix elements are updated based at least in part on a selection by a user of another text element and, thus, may represent text being entered by a user. Text of a prefix text element is included in a prefix of text elements that are arranged in the prefix element's row. The prefix of a text element may include a first letter of the text element. In some implementations, a prefix includes more than one letter that is located at the beginning of each word.

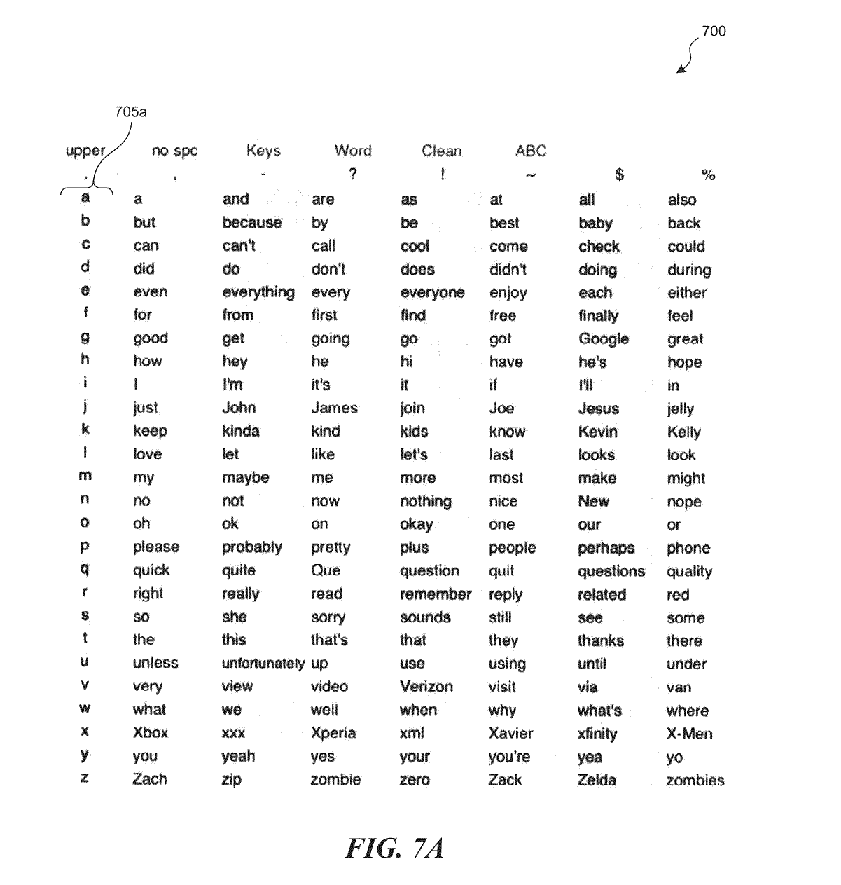

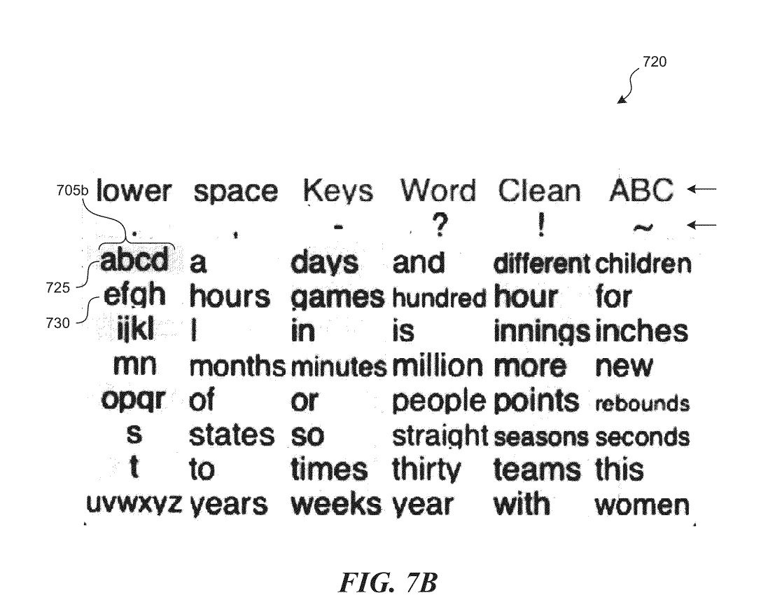

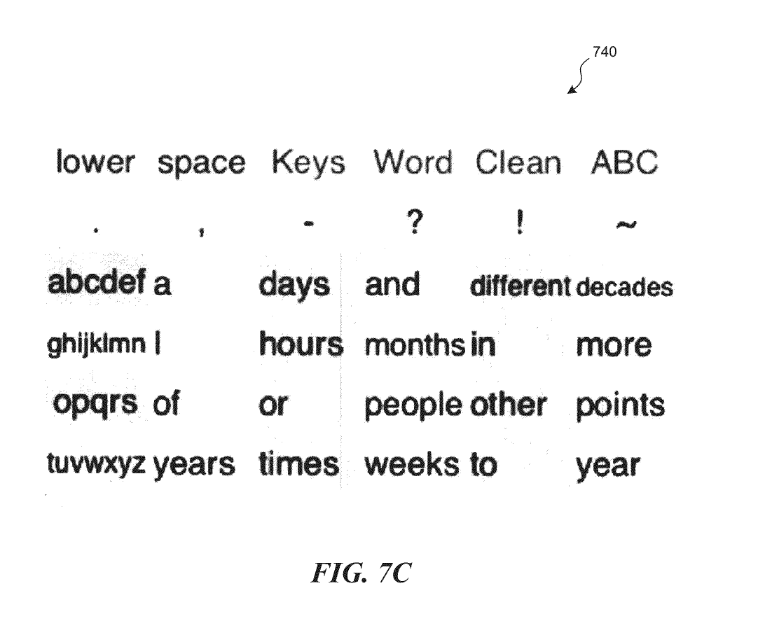

A second column 610 includes “key” text elements. A user may select a key element to add the letter of the key to text being submitted. For example, a user may select a key element corresponding to letter B to add a ‘b’ to text being entered. The system may reflect this selection by appending the ‘b’ to each prefix element, or prepending the ‘b’ to each prefix element if the ‘b’ is the first key element selected. Graphical text element interfaces are discussed in further detail below with respect to FIGS. 6 and 7. In some implementations, text elements of a graphical text element interface are associated with coordinates of a display, and a user's input is compared to the coordinates of the text elements to determine whether a text element was referenced by the user input.

In some implementations, a graphical text element interface does not display prefix text elements. For example, having not received user input, the graphical text element interface may display an alphabetical, vertical arrangement of key elements. And after receiving a user's selection of a key text element, for example of the letter N, rather than automatically displaying prefix text elements of ‘nb,’ ‘nc,’ ‘nd,’ and other unlikely letter combinations, the graphical text element interface displays ‘n’ and only text elements that include the letter N in a plausible combination with other letters. Accordingly, an extra keystroke is needed to enter an obscure letter combination. In some implementations, neither prefix elements nor key elements are displayed, and a graphical text element interface displays text elements, and a user may select a text element to enter text associated with the text element.

When not displaying prefix text elements, the text entry system can better consider multiple text elements for an ambiguous selection by a user, such as when two or more text elements are associated with a user's touch on a touch screen display. Indeed, the text entry system is not burdened with displaying the already-inputted text in combination with every letter of the alphabet. As a result, it can display text elements identified as probable based on the user's prior input corresponding to any of two or more text elements. For example, if the text entry system has identified that the user may have intended to enter either of two text elements by an input, such as the text element for ‘a’ and the text element for ‘s,’ the system can display text elements consistent with either selection, such as “and,” “aunt,” “so,” and “such.” When a user selects a text element that is displayed as a result of a prior ambiguous selection, the text entry system adjusts probability characteristics associated with displayed text elements. For example, if a user selects a text element of the word “ma,” the text entry system would adjust probability characteristics of displayed text elements so that all displayed text elements included “ma” in their corresponding word.

The system may identify multiple text elements for a given input based at least in part on at least one of the following: a distance between coordinates of a user input and reference coordinates associated with text elements and a statistical likelihood that a text element was selected (e.g., based on character language models (character n-grams)). The text entry system may omit prefix elements from a graphical text element interface in a variety of implementations. For example, they may be omitted because the user is only expected to enter a known or common phrase, or because a different display (e.g., a traditional QWERTY keyboard), is to be used to enter unusual words.

The “environmental parameters” describe a computing device, a computing environment, and/or a physical environment of a device that the system is implemented in. For example, environmental parameters may identify input mechanisms available (e.g., touchscreen, television remote control, etc.) to a device for receiving user input. Environmental parameters may describe a display for displaying a graphical text element interface. For example, environmental parameters may identify a size of a display that the graphical text element interface is to be displayed on. Environmental parameters may also identify an area of a display that is available for displaying a graphical text element interface. For example, in addition to identifying a size of a display, environmental parameters may specify that a graphical text element interface is to cover half of the available display. In some implementations, environmental parameters specify a number of rows for the graphical text element interface. For example, environmental parameters may specify that the graphical text element interface is to only include five rows of text elements. In some implementations, environmental parameters are specified by the user or a third party.

User input includes data describing a user's interaction with a graphical text element interface. How user interaction is expressed may vary based at least in part on a device that the system operates in. In some implementations, user input includes measurements captured by a sensor or other device. For example, for a mobile device having a touchscreen, user input may include coordinates of points touched by the user and time measurements for how long or when the user touched those points. For a wearable computer, like Google Glass™, user input may include measurements of movements by a person's eye or another body part, or input via a touch-sensitive device or image sensor system. Similarly, for a video game console, user input may include motion of a user captured by image sensors. In some implementations, user input includes discrete selections or instructions. For example, user input may be received via a gamepad, television remote control, or a controller with a scroll wheel, and the user input may include data representing a selection of a text element and/or instructions to move a cursor displayed on a graphical text element interface. In some implementations, user input includes audio input that the system matches to text elements or to a selection sound.

Entered text includes text entered by a user into a device via the text entry system 300. Entered text may be words, letters, numbers, symbols, images, and the like. Entered text may be output to another application operating in the computing environment of the system. In some implementations, the text entry system outputs entered text after receiving a user's instruction to do so. For example, the system may output text after the user selects an “enter” key. In some implementations, the text entry system outputs entered text after a user enters a word or after the user selects a text element.

The text entry system 300 generates a graphical text element interface for displaying text elements to a user. The system may identify an arrangement for displaying text elements to the user and text elements to arrange in the arrangement based at least in part on environmental parameters and user input. The text element interface module 310 identifies text elements to include in a graphical text element interface and an arrangement and style for the interface. The text element interface module 310 obtains layout information for a graphical text element interface in graphical interface data storage 365. Graphical interface data storage 365 includes configuration parameters for different arrangements of text elements, including parameters for various layouts of the text elements. In some implementations, the text element interface module identifies an appropriate arrangement for the graphical text element interface based on received environmental parameters. For example, environmental parameters may specify that the text entry system 300 is operating in a smartphone that has a 4-inch touchscreen display. Based on these parameters, the text element interface module may identify an arrangement that includes, for example, six rows and eight columns, and that covers an area that is ⅔ to 9/10 of the display.

The text element interface module 310 identifies text elements for a graphical text element interface in the text element data storage 360. The text element interface module 310 identifies text elements based at least in part on environmental parameters, word usage data, predicted likelihood that a user will desire to enter text of a text element, and/or user input. Metadata may be associated with text elements. Metadata includes word usage rates (e.g., third party usage data, user usage data, regional usage data, historical usage rates, trends in usage etc.), a word type associated with a text element (e.g., a part of speech), previous selections by the user, a relative importance of a text element (e.g., high importance if a name in a contact list), an association between text elements, and so forth. The metadata may be received from third parties or gathered by the text entry system based on input from a user. The text element interface module compares information associated with received environmental parameters and/or user input to text elements and metadata associated with text elements to identify text elements to include in a graphical text element interface. For example, the text entry system may receive a user's selection of displayed text element corresponding to the word “cat” and identify for a graphical text element interface a next text element corresponding to the word “purr.” In some implementations, the text element interface module predicts text from preceding text using n-gram tables, which list a prefix (e.g., “cat”), which has already been entered by the user, and the likelihood regarding what the next word will be (e.g., “purrs”) The predicted likelihoods represented in the n-gram tables may be calculated by analyzing many samples of text and tallying the number of times that a word or words follow particular prefixes of varying numbers of words. In some implementations, the text data storage includes data specifying default text elements to be used in a graphical text element interface. For example, text data storage may include data specifying a default grouping of text elements for a graphical text element interface that is a two-dimensional table having six rows and eight columns.

Text element data storage may store text elements and associated data in a variety of ways, including in a text file, a spreadsheet, a database, and so forth. Indeed any suitable data structure may be used. The text entry system 300 may obtain text elements from many sources, including text of dictionaries, webpages, email messages sent or received by the user, SMS messages sent or received by the user, contact details (e.g., names associated with contacts of the user), text entered by the user via the text entry system, and so forth.

The text element interface module 310 receives selection information from the selection identification module 320, and information related to actions implemented as a result of the selection from the selection implementation module 330. The information from these modules may include, for example, that the user selected a text element or that the user selected to add a portion of a text element to a word being entered. The text element interface module may compare information received from both the selection identification module and selection implementation module, with text elements and metadata associated with text elements, in order to identify text elements to include in a graphical text element interface. For example, the text element interface module can identify relevant text elements to present to the user by comparing stored text elements to text previously entered by a user. The text element interface module can use a next word prediction to identify text elements.

The text element interface module 310 often identifies more text elements for display than are capable of being displayed in a graphical text element interface. The system may receive input from the user to browse additional text elements that are not initially displayed. For example, the system may receive a swipe from right to left across a text element interface and display a new page of text elements.

The selection identification module 320 examines user input to identify whether a user has selected a text element and to determine a type of selection intended by the user. The text entry system may take a particular action as a result of the identified intent of the user. In some implementations, the selection identification module distinguishes between a first type of selection corresponding to a user's intent to enter text associated with a text element, and a second type of selection corresponding to a user's intent to add at least a portion of a selected text element to text being entered. For example, the selection identification module may identify a tap received via a touchscreen device as an instruction to enter text associated with a selected text element, a swipe to the left starting on the text element as an instruction to add the first two characters of the selected text element to text being entered, and a swipe down starting on the text element as an instruction to replace characters of text being entered with a prefix from the selected text element. In some implementations, the selection identification module identifies handwritten gestures and takes a particular action based on a received handwritten gesture. For example, the system may receive a handwritten input of the letter A and refine text elements displayed to the user based on the received handwritten input.

The selection identification module 320 can identify multiple text elements associated with a user input and determine which has the highest probability of being intended by the user for selection. For example, if the system identifies a selection of a text element for the letter M among a vertical, alphabetical arrangement of text elements, the system can process the text element for letter M as the most probable selection, but the system can also process the text elements for letters L and N as possible selections. The system can also identify possible text elements based on user input corresponding to a selection of multiple text elements. For example, the system may detect a user's touch over two text elements displayed on a touchscreen device. In some implementations, the system uses character language models (character n-grams) to determine which of the text elements was most likely intended by the user for selection, or whether both were intended, and in what sequence.

The selection implementation module 330 takes an action with respect to a text element based on a selection identified by the selection identification module 320. Actions include entering text corresponding to a selected text element, prepending text being entered with at least one character of a selected text element, changing the prefix of a word being entered, and appending text being entered with at least one character of a selected text element. The text element interface module may modify a graphical text element interface to account for these actions. Likewise, the text entry system may output entered text to account for these actions.

In some implementations, a graphical text element interface includes a command text element. A user may select a command text element to command that the text entry system take a particular action. For example, a command text element may correspond to a “Backspace” key of a keyboard, and the selection implementation module may delete a character or word from previously entered text. The selection implementation module stores information associated with a selection in selection data storage 355. For example, the selection implementation module may store received user input in association with a selection identified based on the user input and an action performed as a result. The selection implementation module may audit its ability to accurately recognize a selection based on historical selection data.

### Example Processes

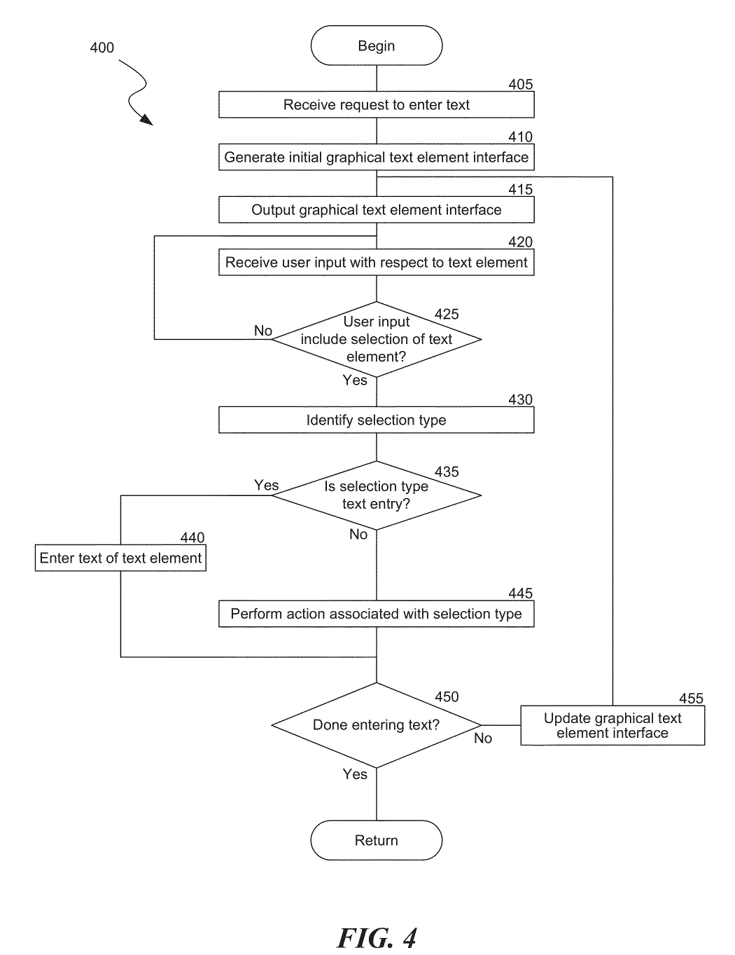

The text entry system 300 generates a graphical text element interface and receives selections by a user of text elements via the graphical text element interface to provide text entry to the user. After receiving a selection by the user of a first text element, the system may replace or remove text elements of the graphical text element interface. That way, the system attempts to narrow the displayed text elements to those corresponding to text that the user wishes to enter, enabling the user to quickly identify and enter text. FIG. 4 is a flow diagram of a process 400 performed by the system 300 for providing for text entry by a user. At a block 405, the system receives a request to enter text. In some implementations, the system receives a request by a user to enter text in an application. For example, a user may select an option displayed by a mobile device to enter text via an application that utilizes the graphical text element interface. Or, the system may be a background application that is invoked when the user selects, e.g., a text entry box in a form, webpage, etc.

At a block 410, the text entry system generates an initial graphical text element interface. In some implementations, the initial graphical text element interface includes a default arrangement of text elements. For example, the system may identify an arrangement for text elements based on a screen size and resolution of a display of a device in which the text entry system is implemented. The arrangement may specify a criterion for groups of text elements to be displayed in the arrangement. For example, the arrangement may specify that the text elements are to be divided into 26 groups according to a first letter of text associated with the text elements. The system may identify text elements for inclusion in the initial graphical text element interface based at least in part on analyzing text element metadata and identifying text elements that fit requirements of the arrangement, including criteria of a group. For example, as discussed above, text elements may be selected for display based at least in part on user, third party, or societal usage rates, a form of speech of a word of a text element, data associated with or gathered from a user (e.g., words taken from SMS messages sent by a user, contact information, social networking data, etc.), or other data. FIG. 6A shows a representative graphical text element interface 600. The interface may be displayed, for example, by a mobile device as an initial graphical text element interface. The text entry system may identify text elements, including “and” 615a, “but” 620, and “are” 625, based on metadata associated with the text elements. For example, each text element may be associated with a usage rate in the English language, and the text entry system may identify most commonly used words beginning with each letter of the alphabet and group the text elements accordingly.

The graphical text element interface 600 of FIG. 6A includes other text elements, including prefix elements 605a and key elements 610. Prefix elements represent text inputted by a user but not entered, such as letters of a word being formed by a user. Prefix elements may update based on a selection by a user of another text element. The text of a prefix text element is included in text elements in cells of the prefix's row, typically located at the beginning of a word. Key elements represent keys that a user may select to enter a word or part of a word letter-by-letter. Selecting a key element adds the text associated with the key to the prefix element of its row. For example, a user may select key elements corresponding to letters B, A, and T, to enter “BAT” letter-by-letter.

In some implementations, the graphical text element interface 600 does not display either prefix elements or key elements. For example, the text element interface may display text elements corresponding to words and phrases, or to prefixes of multiple letters, or phonetic spellings, but include neither key elements nor prefix elements. With no key or prefix elements available, users may still submit single characters. For example, a user can gesture with respect to a displayed text element to add one or more characters to text being entered, depending on the gesture. For example, a user may swipe left with a finger starting on a text element to add a prefix from the text element to text being entered. The graphical text element interface may include an interface element that, if selected, causes the text entry system to display a keyboard, such as a full QWERTY keyboard, through which the user may key single characters. Using a full keyboard, the user can enter words that are unknown to or considered unlikely by the text entry system, which may include passwords or proper names. In some implementations, the system receives handwritten input from a user, which the text entry system recognizes as a submitted character or characters. In some implementations, the system receives audio input from a user, which the system analyzes using a speech-to-text system to identify spoken words in the audio input. The system may accept identified words as user input

The text entry system organizes text elements in groups for the graphical text element interface. In FIG. 6A, text elements are organized in groups by the first letter of text that they are associated with, and the groups are organized alphabetically vertically. Text elements may be grouped in other ways. In some implementations, text elements are grouped phonetically. For example, words starting with ‘c’ and ‘k’ may be grouped together. Groups may be organized in many ways. In some implementations, a group is omitted from a graphical text element interface if no text element in the group has a sufficiently high predicted likelihood of being selected by the user. Similarly, groups may be combined under certain circumstances. For example, groups having text elements with a low predicted likelihood of being selected by the user may be grouped together in an “all other letters” group of an alphabetically arranged grouping of text elements. Similarly, groups may be organized along an axis phonetically rather than based on graphemes.

Returning to FIG. 4, at a block 415, the text entry system 300 outputs the graphical text element interface. The text entry system may cause a device in which the text entry system is implemented to display the graphical text element interface. The text entry system may output the graphical text element interface to an application that displays the graphical text element interface within the application. In some implementations, a device implementing the text entry system outputs the graphical text element interface to another device for displaying the graphical text element interface.

The graphical text element interface 600 shown in FIG. 6A additionally includes a delete element 635, which a user may select to delete previously entered text or text being entered as a result of a text element having been selected. The interface 600 also includes a text entry field 638 and a cursor 640 in the text entry field where a word entered via the graphical text element interface is to appear. In some implementations, the graphical text element interface does not include a text entry field, and instead provides for text input directly in an application. For example, the system may display text elements below a text document, and the user may enter text directly in the text document via the graphical text element interface. The graphical text element interface also shows punctuation marks, and it can include a shift key to capitalize letters or display different punctuation text elements.

The graphical text element interface 600 may display text elements in various ways. Backgrounds of text elements may alternate between different shades or colors to highlight different text elements. A user may view a different set of text elements by swiping across a graphical text element interface, and background color or text displayed on a text element may become more or less pronounced (e.g., brighter or darker), indicating that the system is displaying text elements that are predicted to be more relevant or not as relevant to the user. Cell backgrounds or text of text elements may also be more or less pronounced to reflect next word prediction probability. Rows may also be dimmed or removed based on a low next word prediction probability.

At a block 420, the text entry system 300 receives user input with respect to the graphical text element interface. In some implementations, user input includes coordinates touched by a user on a touchscreen displaying a graphical text element interface. In some implementations, user input includes data representing sensed motion of a user relative to a displayed graphical text element interface. For example, user input may be sensed by image sensors and represent movement or a location of a person's hand or eye relative to a graphical text element interface. In some implementations, user input represents sensed muscle contractions with relation to a cursor displayed on a graphical text element interface. In some implementations, user input includes data representing discrete selections by a user using a button of a device that controls a cursor displayed on a graphical text element interface.

At a decision block 425, the text entry system 300 determines whether user input includes a selection of a text element. The system may identify a selection in user input when user input is consistent with data representing a type of selection and is received in association with a text element. For example, in some implementations, a user may tap a text element on a touchscreen to enter text associated with the text element. The system may interpret a sensed user input of a brief, discrete touch at particular coordinates of a graphical text element interface as a tap associated with a selection to enter text of a text element displayed at the particular coordinates. In some implementations, the system identifies multiple text elements that may have been intended for selection by the user, based on user input.

At a block 430, the system identifies a selection type. In some implementations, the system identifies a selection type by comparing received user input to predetermined requirements for a selection. For example, a predetermined requirement for a tap input corresponding to an instruction to enter text may be that the user input include data representing a user's relatively static contact at a location of a touchscreen over a text element for a time that is less than a predetermined time period. The system may recognize different types of selections of text elements. In some implementations, a selection may include adding the first two characters of a text element to a word being submitted. For example, in some implementations, a user may swipe left on a touchscreen displaying a graphical text element interface to add the first two letters of a text element to a word being entered. In some implementations, a first gesture accumulates characters from a selected text element into a prefix being entered, while another gesture replaces a current prefix being entered with a portion of text from a selected word.

In some implementations, a selection may include handwriting input by a user. For example, the graphical text element interface may include a designated area to receive handwritten input, or the text entry system may provide for handwritten input over text elements of the graphical text element interface. The system may identify characters in the handwritten input. In some implementations, handwritten input includes gestures or symbols that the system recognizes for text entry or as commands. For example, the text entry system may recognize a print character drawing as a print command, or a particular gesture as a command, such as delete, carriage return, or change input modes. The text entry system may also understand gestures as corresponding to a command to enter particular text. For example, the system may determine that a gesture of a triangle corresponds to an instruction to enter a capital A. Other types of gestures include, for example, gestures of symbols that are indicative of letters or prefixes, such as Palm Graffiti-like gestures. Handwritten input may be added to text being submitted by a user (e.g., added to a prefix element), or entered directly as text to the text buffer, depending on an input mode of the text entry system. In some implementations, whether a handwritten input is added to text being submitted or entered directly depends on the handwritten input. For example, if the text entry system detects handwritten input of a punctuation mark, the system may automatically enter the punctuation mark, whereas if the text entry system detects a handwritten character, it may append the character to text being entered but not entered in the text buffer.

At a decision block 435, the system determines whether a selection corresponds to an instruction to enter text. If the system determines that the selection corresponds to an instruction to enter text, the process 400 proceeds to a block 440, and the system enters text associated with a selected text element. In some implementations, the system identifies multiple text elements that are possibly intended by the user for selection. The system may determine which of multiple text elements is most likely to have been intended based on a distance between received user input and where the text element is displayed or statistical likelihood (e.g., from character language models). The system can automatically format entered text. For example, the system may add a space after entered text. FIG. 6B shows the graphical text element interface 600 after text has been entered by a user. Entered text 645 is displayed above text elements. After text is entered, the process 400 proceeds to a decision block 450.

If at decision block 435, the system determines that the selection does not correspond to an instruction to enter text, the process 400 proceeds to a block 445. At block 435, the text entry system 300 performs an action associated with the identified selection type. For example, the system adds a portion of a text element to text being entered if the selection is associated with such an action. If the system has identified two or more text elements as possibly being intended by the user for selection, the system may consider either text element as being selected, and thereafter display text elements chosen based on a selection of either of the text elements.

At a decision block 450, the system determines whether text entry is complete. In some implementations, the system receives an indication from a user that the user does not wish to enter text any longer. For example, the system may receive user selection of a displayed option to cease entering text. If the system determines that text entry is complete, the process 400 returns. If the system determines that text entry is not complete, the process proceeds to a block 455, and the system updates the graphical text element interface based on the selection of the text element.

In some implementations, the system updates the graphical text element interface by identifying text elements to display based on text entered by a user. For example, if a user enters the word “drinking,” the system may identify words associated with drinking, such as “soda,” “water,” “beer,” and so forth, and include text elements corresponding to these words in the graphical text element interface. In some implementations, the system updates the graphical text element interface by identifying text elements to display based on a text element merely selected by a user. For example, if a user selects to add a letter to a word being entered, the system may update the graphical text element interface to display text elements of words that include the letter. Referring again to FIG. 6B, the user has selected to add a ‘w’ to a word being entered, either by selecting a key element for ‘w’ or by selecting a text element in a way to add a ‘w’ to the word being entered. The system filters text elements to include only those that are associated with text that start with ‘w’. Additionally, the system has updated the prefix column 605b to include ‘w’.

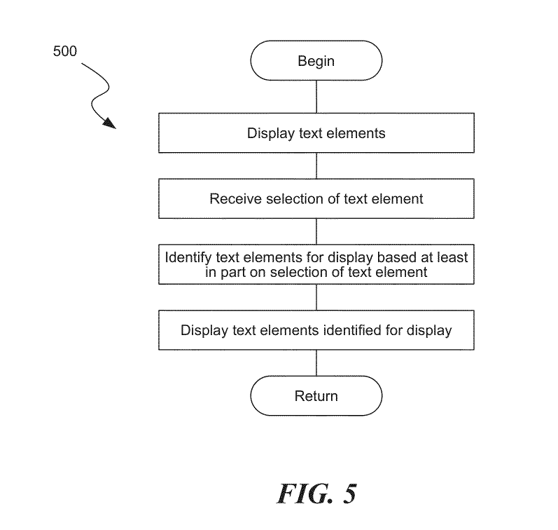

FIG. 5 is a flow diagram of a process 500 performed by the text entry system 300 for updating a graphical text element interface. At a block 510, the system 300 displays text elements in a graphical text element interface. At a block 520, the system 300 receives a selection by a user of a text element. The selection may be associated with an instruction to refine displayed text elements based on the selected text element and the type of selection. In some implementations, the system receives user input to scroll through text elements not currently displayed by the graphical text element interface. For example, the system may interpret a swipe right as an indication to replace all text elements with new text elements. At a block 530, the system identifies text elements for display in the graphical text element interface based at least in part on the selection of the text element. At a block 540, the system displays text elements in the graphical text element interface that are identified based at least in part on the selection.

### Example Interfaces

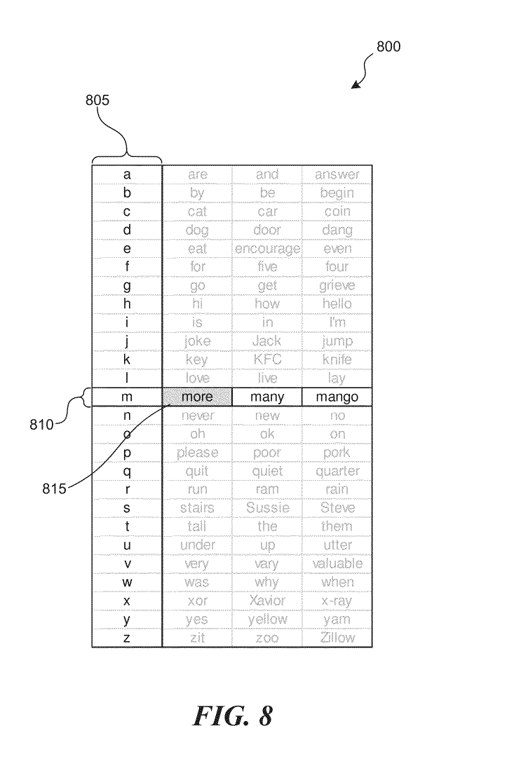

The system 300 arranges graphical text element interfaces in various ways. FIGS. 7 and 8 show example graphical text element interfaces. FIG. 7A shows a graphical text element interface 700 that includes 26 rows of text elements and a row of command and punctuation text elements on top of the 26 rows. The text element interface 700 does include key text elements 705 but does not include prefix elements. In some implementations, the system receives an input of a letter when a user selects a key element 705. In some implementations, prefix elements are shown as single, or a small number of elements. For example, rather than showing prefix elements “ma,” “mb,” “mc,” etc., after receiving a selection of a key corresponding to letter M, a single “m” prefix element can be presented. Sometimes, rather than display the single “m” prefix element, the system displays other prefix elements associated with an input of letter M. For example, the system may display prefix elements that incorporate vowels, such as “ma,” “me,” “mi,” “mo,” “mu,” and “my.”

FIG. 7B shows a graphical text element interface 720 that includes eight rows of text elements. Some key elements 705b are associated with multiple letters, similar to how letters are grouped for T9-style input, under which multiple letters are associated with each of the nine numbers displayed on a keypad of a phone. (T9-style input is discussed in assignee's U.S. Pat. No. 5,818,437, issued Oct. 6, 1998.) For example, a first key element 725 is associated with letters A, B, C, and D, and a second key element 730 is associated with letters E, F, G, and H. Text elements in a row of a prefix element all start with one of the letters of the prefix element. In some implementations, letters are grouped together based at least in part on desirability of text elements that start with the letter. For example, fewer words start with letters U, V, W, X, Y, and Z than the letter T. Thus, in order to display more text elements that start with the letter T, the system displays a prefix element for letter T alone, and groups letters U, V, W, X, Y, and Z together in one prefix element. In the row with the prefix element for U, V, W, X, Y, and Z are a group of text elements selected based at least in part on text associated with those text elements beginning with one of these letters, such as “year,” “weeks,” “yes,” “with,” and “woman.” FIG. 7C shows a graphical text element interface 740 that has only four rows of text elements, which would be used with an even smaller screen than that for FIG. 7B.

FIG. 8 shows a graphical text element interface 800 that is representative of an interface for providing for one dimensional display of text elements. For example, the system 300 may be implemented in a device that has a display that is limited in capacity to displaying only one text element at a time. And the system may only receive user input via a limited capacity device, such as a device with a scroll wheel or few input buttons. Using the simple input mechanism of the device, a user may advance a select cell 815 displayed by the device through a first dimension 805 of text elements (e.g., moving “up” and “down” the first dimension of text elements), select a text element, such as the text element for letter M, and then scroll through a second dimension 805 of text elements (e.g., moving “left” and “right” through the second dimension of text elements), which are identified based on the selection of the text element. In some implementations, the system receives a selection to filter text elements by a letter or a combination of letters chosen from a displayed text element. For example, a user may press a button twice while the select cell is highlighting a text element, and the system may filter text elements based on the first two letters of the text element.

The text entry system can generate various graphical text element interfaces. In some implementations, prefix elements are in a different column than the first column of a table. Alternatively, prefix elements may be arranged in a row. For example, prefix elements may be arranged horizontally at the top of a graphical text element interface. In some implementations, text elements are highlighted based on a predicted likelihood that the user desires to enter text of the text element. For example, a text element that is identified as most probable based on usage, context (e.g. last word or words entered), etc. may be highlighted in a deep green color and those that are determined to be less probable are highlighted in a lighter shade of green.

The text entry system can display text elements with different background colors to represent a relative probability of the user desiring that text. The system can also dim text elements to represent a determined probability. The text entry system can be combined with other text input systems or mechanisms. For example, the text entry system can be used in a device that utilizes a traditional keyboard that is either virtual or physical. For example, a traditional keyboard may be displayed below text elements, or it may replace the text elements (e.g., by use of a toggle user interface element), and the traditional keyboard may be used to quickly enter a prefix or word. In some implementations, the text entry system does not update the graphical text element interface after each selection by a user. For example, the text entry system may update displayed text elements only after each entered word or after a selection of a prefix.

The system may be paired with a speech to text system to provide for voice recognition and a user's selection of text elements identified based on spoken words. Or the text entry system may receive a selection by a user via spoken word or a sound. The text selection display may follow text entered by voice, and voice input may be used for text entry, for character entry, and for election of text entries, alone, or in combination with positional selection and gestures.

The text entry system described herein can facilitate text entry for many different types of devices, enabling efficient text entry in devices that are otherwise cumbersome for text entry. The text entry system can improve efficiency of text entry in mobile devices, wearable devices, video game consoles, word processing devices for the physically impaired, and so forth. The system may use much larger language models than traditional next word prediction. The system may also use a personalized language model.

Those skilled in the art will appreciate that the actual implementation of a data storage area may take a variety of forms, and the phrase “data storage area” is used herein in the generic sense to refer to any area that allows data to be stored in a structured and accessible fashion using such applications or constructs as databases, tables, linked lists, arrays, and so on.

### CONCLUSION

Systems and modules described herein may comprise software, firmware, hardware, or any combination(s) of software, firmware, or hardware suitable for the purposes described herein. Software and other modules may reside on servers, workstations, personal computers, computerized tablets, PDAs, and other devices suitable for the purposes described herein. Modules described herein may be executed by a general-purpose computer, e.g., a server computer, wireless device, or personal computer. Those skilled in the relevant art will appreciate that aspects of the invention can be practiced with other communications, data processing, or computer system configurations, including: Internet appliances, hand-held devices (including personal digital assistants (PDAs)), wearable computers, all manner of cellular or mobile phones, multi-processor systems, microprocessor-based or programmable consumer electronics, set-top boxes, network PCs, mini-computers, mainframe computers, and the like. Indeed, the terms “computer,” “server,” “host,” “host system,” and the like, are generally used interchangeably herein and refer to any of the above devices and systems, as well as any data processor. Furthermore, aspects of the invention can be embodied in a special purpose computer or data processor that is specifically programmed, configured, or constructed to perform one or more of the computer-executable instructions explained in detail herein.

Software and other modules may be accessible via local memory, a network, a browser, or other application in an ASP context, or via another means suitable for the purposes described herein. Examples of the technology can also be practiced in distributed computing environments where tasks or modules are performed by remote processing devices, which are linked through a communications network, such as a Local Area Network (LAN), Wide Area Network (WAN), or the Internet. In a distributed computing environment, program modules may be located in both local and remote memory storage devices. Data structures described herein may comprise computer files, variables, programming arrays, programming structures, or any electronic information storage schemes or methods, or any combinations thereof, suitable for the purposes described herein. User interface elements described herein may comprise elements from graphical user interfaces, command line interfaces, and other interfaces suitable for the purposes described herein.

Examples of the technology may be stored or distributed on computer-readable media, including magnetically or optically readable computer disks, hard-wired or preprogrammed chips (e.g., EEPROM semiconductor chips), nanotechnology memory, biological memory, or other data storage media. Indeed, computer-implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme).

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the invention provided herein can be applied to other systems, not necessarily the systems described herein. The elements and acts of the various examples described above can be combined to provide further implementations of the invention.

Any patents and applications and other references noted above, including any that may be listed in accompanying filing papers, and the assignee's U.S. patent application Ser. No. 14/106,635, filed Dec. 13, 2013, are incorporated herein by reference. Aspects of the invention can be modified, if necessary, to employ the systems, functions, and concepts of the various references described above to provide yet further implementations of the invention.

These and other changes can be made to the invention in light of the above Detailed Description. While the above description describes certain examples of the invention and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

To reduce the number of claims, certain aspects of the invention are presented below in certain claim forms, but the applicant contemplates the various aspects of the invention in any number of claim forms. For example, while only one aspect of the invention is recited as a means-plus-function claim under 35 U.S.C sec. 112, sixth paragraph, other aspects may likewise be embodied as a means-plus-function claim, or in other forms, such as being embodied in a computer-readable medium. (Any claims intended to be treated under 35 U.S.C. §112, ¶6 will begin with the words “means for”, but use of the term “for” in any other context is not intended to invoke treatment under 35 U.S.C. §112, ¶6.) Accordingly, the applicant reserves the right to pursue additional claims after filing this application to pursue such additional claim forms, in either this application or in a continuing application.

I/We claim:

1. A method performed by a computing system, which has at least one processor and a memory, for receiving text entry by a user, the method comprising:
receiving an indication to provide text entry capabilities to a user;
determining an arrangement of text elements for display to the user,
wherein the arrangement includes a first set of text elements arranged visually along a first axis,
wherein each of the text elements along the first axis represent at least one letter of an alphabet, and
wherein all letters of the alphabet are included in the first set of text elements arranged visually along the first axis,
identifying a second set of text elements,
wherein each text element of the second set of text elements represents at least a word;
matching a prefix of each word represented by the text elements of the second set of text elements with a text element of the first set of text elements;
arranging each text element of the second set of text elements visually along a second axis with the text element of the first set of text elements that matches the prefix of the word represented by the text element of the second set of text elements;
outputting the arrangement of text elements including the first set of text elements and the second set of text elements for display to the user, and receiving a selection by the user of a text element of the second set of text elements.

2. The method of claim 1, further comprising:
identifying a third set of text elements,
wherein each text element of the third set of text elements represents a word, and
wherein the third set of text elements includes text elements identified based at least in part on the selection by the user of the text element from the second set of text elements;
removing the second set of text elements from the arrangement of text elements;
adding the third set of text elements in the arrangement of text elements; and
receiving a selection by the user of a text element of the third set of text elements.

3. The method of claim 2, further comprising adding to the first set of text elements at least part of the word represented by the text element of the second set of text elements selected by the user.

4. The method of claim 2, further comprising outputting the word associated with the text element of the third set of text elements selected by the user.

5. The method of claim 2, further comprising outputting the word associated with the text element of the second set of text elements selected by the user.

6. The method of claim 2, further comprising:
adding to the first set of text elements at least part of the word represented by the text element of the second set of text elements, and
outputting the word associated with the text element of the third set of text elements selected by the user,
wherein the selection by the user of the text element of the second set of text elements corresponds to a first type of selection,
wherein the selection by the user of the text element of the third set of text elements corresponds to a second type of selection, and
wherein the first type of selection is different from the second type of selection.

7. The method of claim 1, wherein the selection by the user of a text element of the second set of text elements includes a handwriting gesture in relation to the text element.

8. The method of claim 1, wherein the selection by the user of a text element of the second set of text elements is identified based at least in part on measurements related to a body part of the user sensed by a sensor.

9. A tangible computer-readable storage medium containing instructions that when executed by a computing device cause the computing device to receive text entry by a user, comprising:
determining an arrangement of text elements for display to a user,
wherein the arrangement includes a first set of text elements arranged visually along a first axis,
wherein each of the text elements along the first axis represent at least one letter of an alphabet, and
wherein all letters of the alphabet are included in the first set of text elements arranged visually along the first axis,
identifying a second set of text elements,
wherein each text element of the second set of text elements represents a word;
matching a prefix of each word represented by the text elements of the second set of text elements with a text element of the first set of text elements;
arranging each text element of the second set of text elements visually along a second axis with the text element of the first set of text elements that matches the prefix of the word represented by the text element of the second set of text elements; and,
outputting the arrangement of the first set of text elements and the second set of text elements for display to the user.

10. The computer-readable storage medium of claim 9, wherein the method further comprises:
identifying a third set of text elements,
wherein each text element of the third set of text elements represents a word, and
wherein the third set of text elements includes text elements identified based at least in part on a selection by the user of a text element from the second set of text elements;
removing the second set of text elements from the arrangement of text elements;
adding the third set of text elements in the arrangement of text elements; and
receiving a selection by the user of a text element of the third set of text elements.

11. The computer-readable storage medium of claim 10, wherein the method further comprises adding to the first set of text elements at least part of the word represented by the text element of the second set of text elements selected by the user.

12. The computer-readable storage medium of claim 10, wherein the method further comprises outputting the word associated with the text element of the third set of text elements selected by the user.

13. The computer-readable storage medium of claim 10, wherein the method further comprises outputting the word associated with the text element of the second set of text elements selected by the user.

14. The computer-readable storage medium of claim 10, wherein the method further comprises:
adding to the first set of text elements at least part of the word represented by the text element of the second set of text elements, and
outputting the word associated with the text element of the third set of text elements selected by the user,
wherein the selection by the user of the text element of the second set of text elements corresponds to a first type of selection,
wherein the selection by the user of the text element of the third set of text elements corresponds to a second type of selection, and
wherein the first type of selection is different from the second type of selection.

15. The computer-readable storage medium of claim 10, wherein the selection by the user of a text element of the second set of text elements includes a handwriting gesture in relation to the text element.

16. A system for receiving text entry by a user, the system comprising:
at least one processor;
at least one data storage device coupled to the at least one processor;
at least one input device, coupled to the at least one processor, to receive or sense an input by a user;
at least one display device to display an arrangement of text elements to the user;
means for determining an arrangement of text elements for display to the user,
wherein the arrangement includes a first set of text elements arranged visually along a first axis,
wherein each of the text elements along the first axis represent at least one letter of an alphabet, and
wherein all letters of the alphabet are included in the first set of text elements arranged visually along the first axis,
means for identifying a second set of text elements,
wherein each text element of the second set of text elements represents a word;
means for matching a prefix of each word represented by the text elements of the second set of text elements with a text element of the first set of text elements;
means for arranging each text element of the second set of text elements visually along a second axis with the text element of the first set of text elements that matches the prefix of the word represented by the text element of the second set of text elements;
means for outputting the arrangement of the first set of text elements and the second set of text elements for display to the user, and
means for receiving a selection by the user of a text element of the second set of text elements.

17. The system of claim 16, further comprising:
means for identifying a third set of text elements,
wherein each text element of the third set of text elements represents a word, and
wherein the third set of text elements includes text elements identified based at least in part on the selection by the user of the text element from the second set of text elements;
means for removing the second set of text elements from the arrangement of text elements;
means for adding the third set of text elements in the arrangement of text elements; and
means for receiving a selection by the user of a text element of the third set of text elements.

18. The system of claim 17, further comprising means for adding to the first set of text elements at least part of the word represented by the text element of the second set of text elements selected by the user.

19. The system of claim 17, further comprising means for outputting the word associated with the text element of the third set of text elements selected by the user.

20. The system of claim 17 wherein the method further co further comprising means for outputting the word associated with the text element of the second set of text elements selected by the user.
